(19) United States
(12) Patent Application Publication
(10) Pub. No.: US 2011/0307262 A1
(43) Pub. Date: Dec. 15, 2011

(54) PREDICTIVE SURVEY CLOSURE

(76) Inventors: Robert Reginald Messer, Ladera Ranch, CA (US); Jonathan Alan Ephraim, Santa Monica, CA (US)

(21) Appl. No.: 12/814,399

(22) Filed: Jun. 11, 2010

(51) Int. Cl. G06Q 10/00; G06Q 90/00

(52) U.S. Cl. 705/1.1; 705/500

(57) ABSTRACT

A method for managing a survey with a plurality of segments is disclosed. First, one or more segments of the survey is presented to a plurality of respondents. An estimated completion rate is derived for at least one of the segments of the survey and may be based upon a number of respondents presented with the respective segment of the survey, and a number of respondents completing the survey. Quota group progress counts of at least one of the segments of the survey for each of the quota groups is derived. Estimated completion counts of each of the quota groups for at least one of the segments of the survey is also derived. The counts are based upon the corresponding quota group progress counts and the estimated completion rates. The method includes closing the survey to subsequent additional respondents of a given quota group.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to quantitative investigations for various fields of inquiry and the management of self-administered polling surveys therefor. More particularly, the present disclosure relates to predictive survey closure.

2. Related Art

Statistical surveys are utilized in a wide variety of settings to collect quantitative data of a population for further analysis and assessment. These uses include political polling, marketing research, social science research, and dispute resolution, among many others. The standardized inquiries made in the surveys may range from the purely factual such as demographics, to opinions, such as how a person feels about an issue or a potential new product, or a combination of both. Surveys are understood to be an efficient method of collecting information from a large number of people, and well-established statistical analyses may be applied to ascertain validity, reliability, and significance.

Generally, marketing research is useful in understanding the wants, needs, and behaviors in the marketplace, both in the present as well as in the future. The research is applied to business-to-business and business-to-consumer applications to better focus product development, marketing, and sales efforts. Due to the typically large numbers of the population that must be surveyed, a substantial investment in time, money, and resources may be necessary.

In the particular context of marketing research, there are understood to be several concerns relating to the conducting of surveys therefor. For many professional market research surveys, there are target limits or quotas for the number of respondents needed for completion. The research objectives may already be fulfilled once that quota is met, with only marginal benefits being realized with the surveying of additional respondents. Accordingly, it is preferable to reach the exact number of complete surveys as designated in the market research parameters as closely as possible without exceeding the limit, especially in cases where the respondent is paid or otherwise compensated. This issue is particularly acute with surveying very particular populations such as a subfield or specialty within a profession. In some cases, the cost per completed survey can reach $100 or more, so excess received responses may result in significant added costs to the sponsor.

Along these lines, it is also typically the goal of survey research to make predictions regarding the preferences of a sample population. Such predictions are easier to make and can be made with greater certainty if the sample population matches the target population. Accordingly, a quota may be defined for each subset or subgroup of the sample population. As a simple example, in the target population, there are known to be 50% males and 50% females; in which case, a quota is set in the sample population for 50% of the respondents to be males and 50% of the respondents to be females. Thus, for a total quota of 1,000 respondents, then 500 are specified to be male and 500 are specified to be female. Other, more sophisticated demographic breakdowns such as age group, ethnicity, or even something as specific as knowledge of a particular brand or products may be utilized. Again, it is preferable to reach the exact number of completed surveys for each of the subgroups, because any excess potentially costs the sponsor additional time and money.

The simplest way of ensuring that these quotas are filled exactly is by conducting the surveys at a slower rate, possibly as slow as one respondent answering at a time. The surveys could be conducted serially while ascertaining whether the various quotas have been reached following each completion. However, with large sample populations, such an approach would be impractical at best, particularly when the surveys must be completed in the span of a few days.

The capability of surveying many people at once in a relatively short period of time makes the Internet, and specifically web-based systems, particularly suitable for conducting surveys. Even with various respondent tracking enhancements, there are several difficulties associated with closing the survey exactly upon the quota(s) being met. These quotas are based upon the number of completed surveys, and not on the number of started surveys, so it is difficult to ascertain the total anticipated number of completions while the survey is still ongoing. Although there are several simple ways in which the number of respondents can be counted, the nature of web pages is such that even after starting, the respondents have the option of navigating away from the survey page. There may be other reasons that respondents may not complete a survey after starting it, such as being disqualified, not matching the characteristics of the target population, and so forth. Accordingly, there is a need in the art for predictive survey closure.

### BRIEF SUMMARY

In accordance with one embodiment of the present disclosure, there is contemplated a method for managing a survey with a plurality of segments. The method may begin with a step of presenting one or more segments of the survey to a plurality of respondents, where each respondent is associated with one or more quota groups. There may also be a step of deriving an estimated completion rate for at least one of the segments of the survey. The estimated completion rate may be based upon a number of respondents presented with the respective segment of the survey, as well as a number of respondents completing the survey. The method may include generating quota group progress counts of at least one of the segments of the survey for each of the quota groups. Additionally, the method may include deriving estimated completion counts of each of the quota groups for at least one of the segments of the survey. The estimated completion counts may be based upon the corresponding quota group progress counts and the estimated completion rates. The method may further include a step of closing the survey to subsequent additional respondents of a given quota group when a total of the estimated complete counts therefor reaches a quota value. The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating one environment in which various embodiments of the present disclosure may be implemented;

FIG. 2 is a block diagram of an exemplary web server;

FIG. 3 is a flowchart depicting the method of managing a survey in accordance with one embodiment of the present disclosure;

FIG. 4 is an example of a set of pages or segments of the survey as would be presented to a respondent;

FIG. 5 is an exemplary completion likelihood table utilized in one embodiment of the method of managing the survey;

FIG. 6 is an exemplary quota group progress table utilized in the method of managing the survey; and

FIG. 7 is an exemplary estimated completion table utilized in the method of managing the survey.

Common reference numerals are used throughout the drawings and the detailed description to indicate the same elements.

### DETAILED DESCRIPTION

The detailed description set forth below in connection with the appended drawings is intended as a description of certain embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first, second, and the like are used solely to distinguish one entity from another without necessarily requiring or implying any actual such relationship or order between such entities.

A method for managing a survey is disclosed in accordance with various embodiments of the present disclosure. In general, the method contemplates filling survey quotas as closely as possible to a specified limit without exceeding the same. This may involve ascertaining, in advance, at which point the survey quota will be filled, and closing the survey to new respondents after that point. Fulfillment of the quota is predicted based upon the number of completed surveys and the number of respondents currently in-progress. Additional details of this method will be discussed more fully below. It is understood that the method may be implemented as one or more computer-executable instructions that can be stored on a data storage medium, though not necessarily limited thereto.

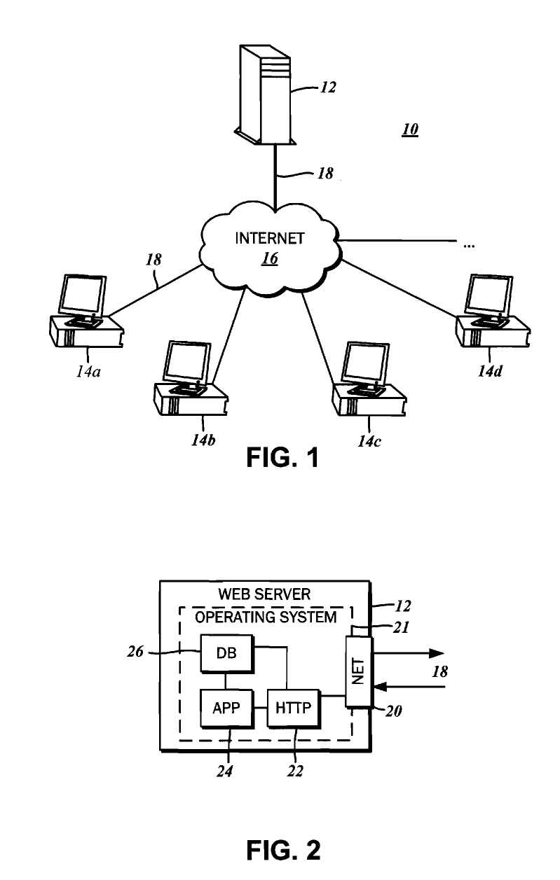

The block diagram of FIG. 1 shows an exemplary environment 10 in which the method for managing the survey may be implemented. Specifically, a web server 12 is in communication with one or more respondent computers 14 over the Internet 16. It is understood that the web server 12 is a conventional computer system having a processor capable of executing the noted instructions of the method, as well as a memory for storing the instructions and other related data. As best shown in FIG. 2, the web server 12 is also understood to have a network interface 20 that is linked to a server Internet connection 18. In this context, the network interface 20 is representative of the physical device connecting the web server 12 to the Internet 16 such as an Ethernet network interface card, as well as the logical module or protocol stack providing the various higher level communications functions for Internet Protocol (IP) networking.

As is the case with most computer systems configured to serve web pages, a base operating system may be running thereon. The operating system may manage one or more server applications that provide including a HyperText Transfer Protocol (HTTP) server 22 that receives requests (in the form of Uniform Resource Identifiers, or URIs) for a specific HyperText Markup Language (HTML) document, and transmits that document back to the requestor. Additional data outside the scope of the document may be retrieved from a separate database 24. Survey data received from the respondent, the details of which will be described more fully below, may also be stored on the database 24. The web server 12 includes and application module 26 that further extends interactivity and web-accessible data processing capabilities.

In an exemplary web-based survey system, data for the various questions may be stored in the database 24. Although it is possible to provide static web pages, the application module 26 may handle the dynamic generation of each page of the survey by populating the same with the questions from the database 24 and incorporating standard content. The HTTP server 22 may then transmit the generated pages to the requestor, i.e., the respondent computers 14, to be rendered thereon by a conventional web browser application well known in the art.

Sending web pages to the requestor is one function performed by the HTTP server 22, and for purposes of conducting the survey, responses to those inquires are also received thereby. As will be recognized, conventional HTML documents have several user input controls such as radio buttons, selection/check boxes, text input boxes, and so forth, that may be utilized to provide responses. The state of the various input controls are submitted to the HTTP server 22, where they are parsed and stored on to the database 24. In accordance with various embodiments, the selection of the HTML forms-based input controls in the survey and providing data to the same is referred to as the submission of a response. The use of alternative input methods is not foreclosed, however, and any other way of submitting information to the web server 12 may be substituted. It is also possible for these submitted responses to alter the execution sequence of the survey or any other set of instructions being performed by the application module 26.

The method for managing the survey may be implemented on the web server 12 in connection with its constituent components including the network interface 20, the HTTP server 22, the database 24, the application module 26, and others as necessary. However, it is expressly contemplated that the system on which to conduct the survey need not be limited to the web server 12 discussed above. The surveys may be conducted over telephone or by paper questionnaire, and the method for managing survey in accordance with the present disclosure is equally applicable thereto. In this regard, the specifics of the web server 12 are presented by way of example only and not of limitation.

The respondent computers 14 are understood to be general-purpose personal computer systems capable of running various applications including the aforementioned web browser application, and is capable of connected to the Internet 16 via individual Internet connections 18. A variety of modalities with respect to the Internet connections 18 are known, and any one may be utilized in order to communicate with the web server 12. In general, the respondent computers 14 are understood to have input and output devices, data storage, and one or more microprocessors. As will be appreciated by those having ordinary skill in the art, the respondent computers 14 may be of any suitable variation, and any number of different respondent computers 14 besides those specifically shown in FIG. 2 may concurrently communicate with the web server 12.

The foregoing description of the various hardware components have been presented by way of example only and not of limitation, and any other suitable component may be readily substituted without departing from the scope of the disclosure. Furthermore, the specific functionalities associated with such components are also exemplary; several different functions may be integrated into a single component, or various subparts of a single function may be performed by several different components.

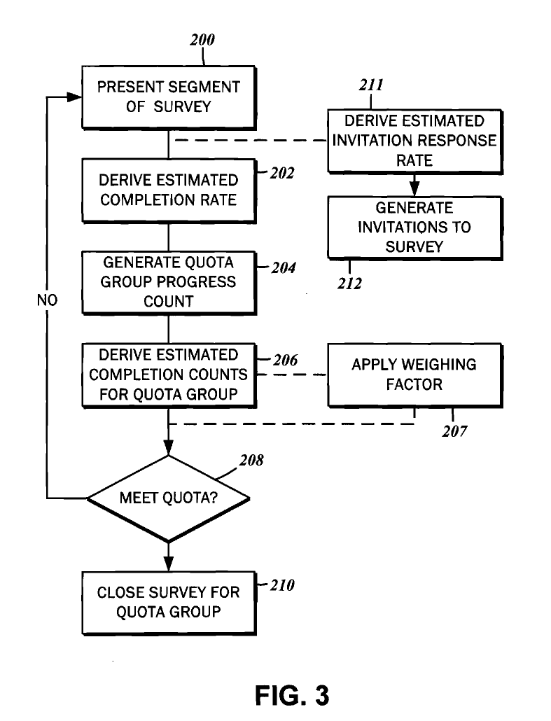

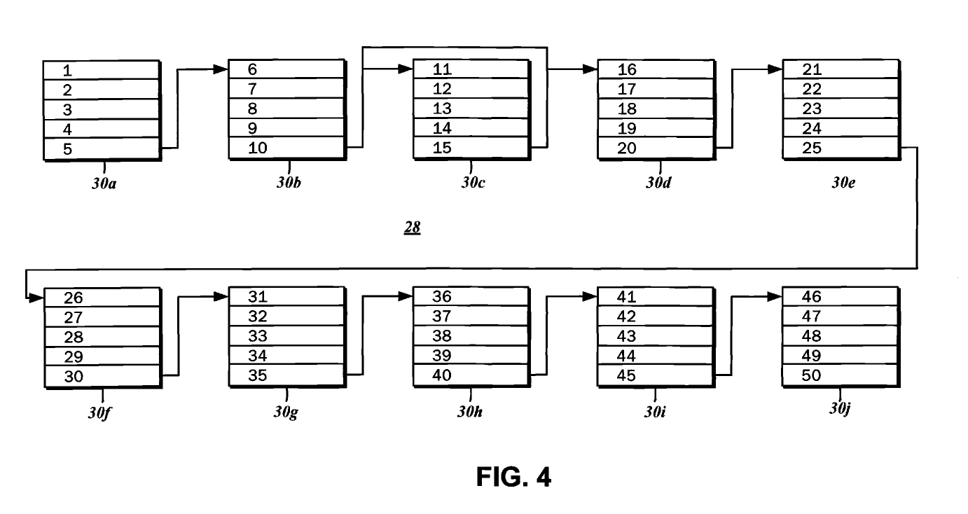

With reference to the flowchart of FIG. 3, the method begins with a step 200 of presenting a segment of the survey to the respondent. FIG. 4 best illustrates an exemplary survey 28 that may be conducted over the Internet 16 and administered by the web server 12 as described above. The survey 28 may be divided into ten segments 30a-30j, or separate web pages. Each of the segments 30 are understood to include one or more questions directed to the respondent. Furthermore, at the end of each of the segments 30, there may be a “continue” button that submits the entered data to the web server 12 and requests the next web page. Each respondent may not necessarily traverse every one of the segments 30, and there may be some questions that, when answered one way or another, redirects the respondent to a different question out of sequence, possibly on a different segment 30. This is known in the art as branching, where responses to earlier responses determine which further questions are to be answered. In the context of the paper questionnaire that is manually submitted in piecemeal fashion, the above-described segments may correspond to a set of one or more questions printed thereon. The segments may span a single page, or multiple pages.

By way of example, for the purposes of the research being conducted, the sponsor may require 500 male respondents and 500 female respondents. These subgroups of the general respondent pool are referred to as quota groups. Thus, 500 male respondents are to be in the male quota group, and 500 female respondents are to be in the female quota group. While the present example involves gender quota groups, any other dividing characteristic or demographic may be used to define a quota group, such as age, ethnicity, family size, income level, education level, etc. In more generalized surveys, the entire sample may constitute one quota group. Various embodiments also envision there being more than one quota group that are not mutually exclusive; for example, one set of quota groups may be gender, while another set of quota group may be age group. Thus, one respondent may fall into one gender quota group, and at the same time also fall into one age group. For purposes of simplification in describing the contemplated feature of closing the survey at different points for multiple quota groups, however, the following example only involves a singe quota group-gender.

In the example survey 28, invitations may be sent to 10,000 potential respondents, though, as will be appreciated, different circumstances may warrant a different number of invitations. All of the invitations can be sent out at once, though it may be staggered to account for different time zones and to flatten peak bandwidth requirements over time. It is understood that not all 10,000 potential respondents will begin and end the survey 28 at the same time, as respondents may be in different time zones, or attend to their e-mail at different times to receive the invitation. Certain conclusions can be drawn from an earlier sub-pool of respondents to extrapolate it to the total pool respondents, that is, the likelihood that future respondents will complete the survey 28, per survey segment 30, may be predicted.

Referring again to the flowchart of FIG. 3, the method may continue with a step 202 of deriving an estimated completion rate for at least one of the segments 30 of the survey 28. Generally, this is based upon the number of respondents presented with that particular segment 30, and of those particular respondents, how many ultimately completed the survey 28.

It is understood that there are several reasons why a survey that is started does not proceed to completion. In relation to the example survey 28, as is common with a variety of surveys, qualification questions are presented in the first segment 30a, after the survey 28 is initiated. These questions may disqualify some respondents based upon them being in a demographic that is not a part of the target population, or lacking experience or knowledge with regard to the subject matter of the survey 28, for example. In such case, a polite rejection may be generated, with no further responses being accepted from that respondent. Additionally, as indicated above, a respondent may simply lack time or interest for completion, and navigate away from the survey 28.

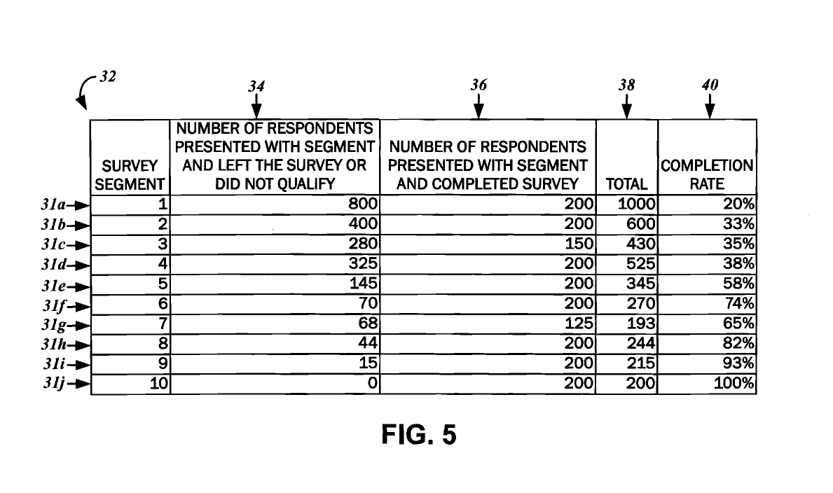

Over the course of receiving answers from several respondents, the above-described information is acquired and the estimated completion rate is derived. FIG. 5 depicts completion likelihood table 32 having multiple rows 31a-31j corresponding to each of the segments 30a-30j of the survey 28. Within each row 31, or for each segment 30 of the survey 28, the number of respondents presented therewith but did not complete the survey is recorded in a first column 34. For purposes of the contemplated method, a period of inactivity exceeding a predetermined duration may be considered leaving the survey. In accordance with one embodiment of the present disclosure, this duration may be approximately 30 minutes. Additionally, the number of respondents presented with that segment and did complete the survey is recorded in a second column 36. The total number of respondents presented that segment is recorded in a third column 38. The value of the third column 38 is understood to be the sum of the value in the first column 34 and the value in the second column 36. From the total number of respondents, a completion rate is calculated and recorded as a percentage in a fourth column 40. The completion rate is understood to be the quotient of a dividend value in the second column 36 and a divisor value in the third column 38.

The values of the completion likelihood table 32 are updated as new respondents complete the survey 28, but do not account for currently in-progress respondents. The final status of such in-progress respondents is not yet known, so including those respondents amongst those who actually did not qualify or complete the survey 28 would lead to improperly reduced completion rates and inaccurate survey closing. As shown in the exemplary completion likelihood table 32, the number of respondents presented with the segments 30 progressively decreases as the respondents continue further into the survey 28 towards completion. For example, whereas 800 respondents are presented the first segment 30a, only 400 are presented the second segment 30b. With each new segment 30, additional respondents may leave or otherwise terminate the survey 28. In some cases, the number of respondents presented with a subsequent segment 30 may be more than a previous one. One illustrative example is the fourth segment 30d, which was presented to 325 potential respondents, but the previous third segment 30c was presented to 280 respondents. This is understood to be a scenario where a branch in either of the earlier segments 30, first segment 30a or second segment 30b, included a branch that skipped over the third segment 30c to jump to the fourth segment 30d. Accordingly, the total number of respondents completing the survey 28 after being presented with the third segment 30c is lower, at 150, in comparison to the 200 respondents completing the survey 28 after being presented with the fourth segment 30d.

Referring again to the flowchart of FIG. 3 method continues with a step 204 of generating a quota group progress count of at least one of the segments 30 of the survey 28 for each of the quota groups. Generally, the quota group progress counts are a sum of the number of respondents associated with the quota group having completed the survey, and a fraction of respondents associated with the quota group currently in progress of completing the one of the segments 30 of the survey 28. As indicated above, the fraction of the respondents associated with the quota group is based upon the derived estimated completion rate.

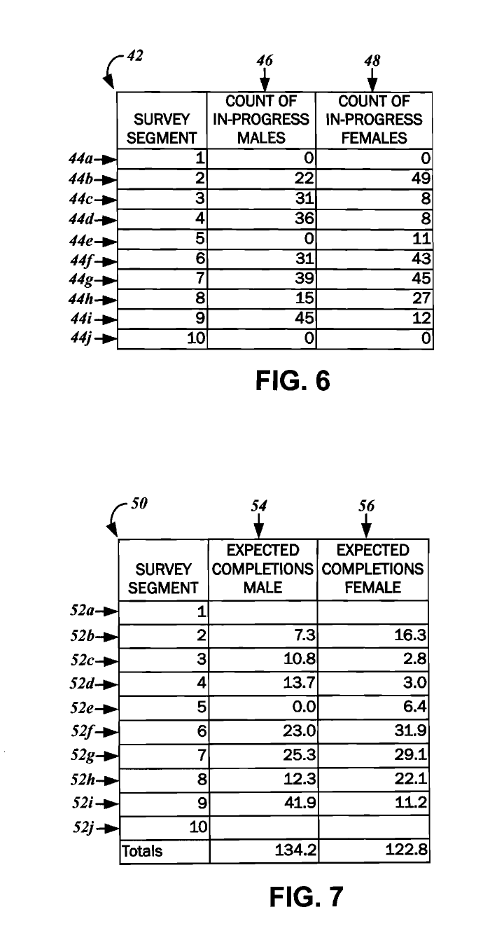

With particular reference to FIG. 6, a quota group progress table 42 tracks the aforementioned progress count data, and includes a row 44 for each of the segments 30a-30j of the survey 28. As noted above, in the example set forth herein, there are two mutually exclusive quota groups—one for the male gender, and one for the female gender. The quota group progress counts for these quota groups are stored in a first column 46 and a second column 48, respectively. As utilized herein, the quota group progress count is understood to be a tally of the number of respondents currently answering the survey 28, and the value thereof associated with a particular segment 30 corresponds to the number of respondents currently reaching that segment. Thus, for example, in the second row 44b of the quota group progress table 42, 22 male respondents and 49 female respondents have currently reached the second segment 30 or page in the survey 28. Again, the quota group progress counts do not include those respondents who have not submitted any data within a specified time limit. The quota group progress count corresponding to the first segment 30a is understood to be zero because the respondent's gender has not yet been submitted to the web server 12. Similarly, the quota group progress count corresponding to the tenth segment 30j is also understood to be zero because upon submitting responses thereto, the survey 28 is deemed complete.

The method continues with a step 206 of deriving estimated completion counts of each of the quota groups for at least one of the segments 30. The estimated completion count is understood to be based upon the estimated completion rate and the quota group progress counts. In particular, for each segment 30, the associated estimated completion rate (in percentages) is multiplied by the each of the corresponding quota group progress counts. An estimated completion table 50 shown in FIG. 7 includes a plurality of rows 52a-52j, each being designated for the corresponding one of the segments 30a-30j. A first column 54 is designated for the estimated completion count for the male quota group, and a second column 56 is designated for the estimated completion count for the female quota group. For example, the estimated completion rate for the third segment 30c, as shown in the completion likelihood table 32 of FIG. 5 is 35%, and the corresponding quota group progress count for the make quota group is 31. Thus, out of the 31 respondents currently in-progress following a submission of responses to the third segment 30c, it is estimated that approximately 10.8 of those 31 will eventually complete the survey.

For each quota group, the total estimated number of completed surveys of all currently in-progress segments 30a-30j is summed. By way of example, the total estimated number of completed surveys for the male quota group is 134.2, and the total estimated number of completed surveys for the female quota group is 122.8. These sums are further added to the respective number of total completed surveys for each quota group. If, for example, there were 100 completed surveys from the male quota group, the estimated completion count therefore is 234.2. Similarly, if there were 100 completed surveys from the female quota group, the estimated completion count is 222.8, for a total of 457 surveys completed if no further respondents were allowed. In this way, it can be projected ahead of time when the requisite quota group totals will be reached.

While various tables with particular arrangements and structures have been considered, including the completion likelihood table 32, the quota group progress table 42, and the estimated completion table 50, these are by way of example and not of limitation. Such tables may be convenient for visualizing the numerous transformative steps that may be performed in accordance with various embodiments of the method for managing the survey 28. Any other suitable data structure may be utilized to derive and generate the aforementioned estimated completion rate, quota group progress counts, and estimated completion counts. Indeed, no organized, table data structure may be necessary.

The method for managing the survey continues with a decision branch 208 when the estimated completion count for each quota group is compared to its corresponding limit. If the limit has been reached with respect to one of the quota groups, then any further respondents that are members of that quota group are no longer accepted, and the survey 28 is effectively closed to them per step 210. Otherwise, if the limit has not yet been reached, additional respondents continue to be accepted, with the estimated completion rates and the quota group progress counts being updated in accordance with steps 202 and 204 as set forth above. By strictly limiting and enforcing respondent quotas, additional time and monetary expenditures resulting from, for example, payment of survey incentives, may be avoided.

Referring again to the flowchart of FIG. 2, it is expressly contemplated that, per step 207, a weighing factor may be applied to the estimated completion counts, such that the sensitivity of the projections is adjusted. It is also envisioned that the weighing factor is completely adjustable by a survey administrator.

The weighing factor can be reduced to lower the total sum of the estimated completion counts. This increases the number of quota group progress counts that are necessary to reach the quota limit. Without prematurely closing the survey 28, it may be completed in a shorter time period. Such an adjustment is suitable if there is little disincentive to exceed the quota limits but there is a need to complete the survey 28 as quickly as possible.

On the other hand, the weighing factor can be increased to increase the total sum of the estimated completion counts, thereby decreasing the number of quota group progress counts necessary to reach the quota limit. Strict enforcement of the quota limit may come at the cost of additional time necessary to complete the entirety of the survey, as many willing and able respondents may be needlessly rejected as the quota limit approaches. This adjustment is understood to be appropriate for a survey 28 that is being conducted on a tight budget, where even minor cost overruns are problematic.

Similar to the way in which the survey 28 is closed in accordance with various embodiments described above, the number of invitations necessary to fill all quota groups may also be ascertained. As shown in the flowchart of FIG. 3, the method may include an alternative, optional step of deriving an estimated invitation response rate. Generally, the estimated invitation response rate is the likelihood that a potential respondent receiving the invitation will activate an embedded link in the communication to begin the survey 28. Along these lines, different communications modalities may be utilized to transmit the invitations, including, but not limited to electronic mail, telephone, text message, postal mail, and so forth, and a different estimated invitation response rate might be derived for each.

The estimated invitation response rate may be derived from the number of respondents invited, the number of respondents completing the first segment 30a of the survey and/or the number of respondents completing the survey 28. In particular, the number of invitations generated may be tracked, along with the number of respondents that begin to answer the first segment 30a of the survey 28. The ratio between the two is understood to be a percentage value representative of the estimated invitation response rate. Instead of tracking the number of respondents that begin to answer the survey, it may track the number of respondents that complete the survey.

With the estimated invitation response rate, the total number of invitations necessary to reach the quota limit is established. For example, if it is determined that 1,000 invitations result in the respondent providing answers to at least the first segment 30a at a 20% rate, then for a 400 quota limit, 2,000 invitations may be necessary. Although this simplified example assumes that the overall respondent pool is the quota group, different estimated invitation response rates may correspond to one of several specific quota groups. After deriving the estimated invitation response rate, the method may continue to an optional step 212 of generating invitations in accordance with the specified number, with the specified modality.

The particulars shown herein are by way of example only for purposes of illustrative discussion, and are presented in the cause of providing what is believed to be the most useful and readily understood description of the principles and conceptual aspects of the various embodiments set forth in the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A method for managing a survey having a plurality of segments, the method comprising:
presenting one or more segments of the survey to a plurality of respondents each associated with one or more quota groups;
deriving an estimated completion rate for at least one of the segments of the survey based upon a number of respondents presented with the respective segment of the survey and a number of respondents completing the survey;
generating quota group progress counts of at least one of the segments of the survey for each of the quota groups;
deriving estimated completion counts of each of the quota groups for at least one of the segments of the survey based upon the corresponding quota group progress counts and the estimated completion rates; and
closing the survey to subsequent additional respondents of a given quota group upon a total of the estimated complete counts therefor reaching a quota value.

2. The method of claim 1, wherein the quota group progress counts are a sum of the number of respondents associated with the quota group having completed the survey, and a fraction of respondents associated with the quota group currently in-progress of completing the one of the segments of the survey.

3. The method of claim 2, wherein the fraction of respondents associated with the quota group is based upon the estimated completion rate.

4. The method of claim 1, wherein the quota groups are derived from responses to demographic queries in the survey.

5. The method of claim 1, further comprising:
closing the survey to a one of the subsequent additional respondents based upon responses to one or more qualifying queries included in a first one of the segments of the survey.

6. The method of claim 1, wherein deriving the estimated completion rate for the one of the segments of the survey includes counting the number of respondents presented with the segment.

7. The method of claim 6, wherein deriving the estimated completion rate for the one of the segments of the survey further includes counting the number of disqualified respondents based upon responses to one or more qualifying queries.

8. The method of claim 6, wherein deriving the estimated completion rate for the one of the segments of the survey includes counting the number of respondents subsequently leaving the survey.

9. The method of claim 8, wherein a respondent is counted as subsequently leaving the survey with a predetermined period of inactivity.

10. The method of claim 1, further comprising:
applying a weighing factor to the estimated completion counts to adjust the sensitivity of projections.

11. The method of claim 10, wherein:
the weighing factor is reduced to lower the estimated completion counts; and
the number of the quota group progress counts being increased to reach the quota based upon the reduced weighing factor.

12. The method of claim 10, wherein:
the weighing factor is increased to raise the estimated completion counts; and
the number of the quota group progress counts being reduced to reach the quota based upon the increased weighing factor.

13. The method of claim 1, further comprising:
deriving an estimated invitation response rate from a number of respondents invited and a number of respondents completing a first one of the segments of the survey; and
generating survey invitations to additional respondents, the number of survey invitations generated being a multiple of the estimated invitation response rate.

14. The method of claim 13, wherein the estimated invitation response rate is further derived from the number of respondents completing the survey.

15. The method of claim 13, wherein a separate invitation response rate is derived for each of one or more communications modalities.

16. The method of claim 15, wherein a one of the communications modalities is selected from a group consisting of: electronic mail, telephone, text message, and postal mail.

17. The method of claim 15, wherein separate invitations are generated for each of the communications modalities based upon the corresponding invitation response rate therefor.

18. The method of claim 1, wherein:
the survey is conducted over the Internet; and
each segment of the survey corresponds to a single web page, each segment including one or more survey questions.

19. The method of claim 1, wherein the survey is conducted over the telephone.

20. The method of claim 1, wherein:
the survey is conducted with a printed questionnaire; and
each segment of the survey corresponds to a set of one or more survey questions.

21. An article of manufacture comprising a program storage medium readable by a computer, the medium tangibly embodying one or more programs of instructions executable by the computer to perform a method for managing a survey having a plurality of segments, comprising:
presenting one or more segments of the survey simultaneously to a plurality of respondents each associated with one or more quota groups;
deriving an estimated completion rate for at least one of the segments of the survey based upon the number of respondents presented with the respective segment of the survey and the number of respondents completing the survey;
generating quota group progress counts of at least one of the segments of the survey for each of the quota groups;
deriving estimated completion counts of each of the quota groups for at least one of the segments of the survey based upon the corresponding quota group progress counts and the estimated completion rates; and
closing the survey to subsequent additional respondents of a given quota group upon a total of the estimated complete counts therefor reaching a quota value.
